(19) United States
(12) Patent Application Publication
(10) Pub. No.: US 2020/0051021 A1
(43) Pub. Date: Feb. 13, 2020

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventors: Fumiki OHTANI, Toyota-shi (JP); Hirofumi KAMIMARU, Fukuoka-shi (JP); Riho MATSUO, Nagoya-shi (JP); Shodai KATO, Toyota-shi (JP); Atsushi YOSHIDA, Tokyo-to (JP); Shunsuke TANIMORI, Susono-shi (JP)

(73) Assignee: TOYOTA JIDOSHA KABUSHIKI KAISHA, Toyota-shi (JP)

(21) Appl. No.: 16/529,139

(22) Filed: Aug. 1, 2019

(30) Foreign Application Priority Data
Aug. 9, 2018 (JP) 2018-150399

(51) Int. Cl. G06Q 10/08

(52) U.S. Cl. CPC G06Q 10/08355

(57) ABSTRACT

Re-delivery of a package is efficiently performed in a case where a package is not handed over when the package is delivered. Failure to hand over a package by delivery of the package by a first vehicle in which the package that is scheduled to be delivered to a delivery des in ti loaded is detected; and matching, with the vehicle, of a second vehicle that is different from the first vehicle and for which a condition allowing reloading of the package from the first vehicle and a condition allowing delivery of the package to the delivery destination are established is performed, in a case where failure to hand over the package is detected, where matching is performed on the basis of information about traveling of the first vehicle, information about the package, and information about traveling of the second vehicle.

### CROSS REFERENCE TO RELATED APPLICATION

This application claims the benefit of Japanese Patent Application No. 2018-150399, filed on Aug. 9, 2018, which is hereby incorporated by reference herein in its entirety.

### BACKGROUND

### Technical Field

The present disclosure relates to an information processing apparatus, an information processing method, and a program,..

### Description of the Related Art

With respect to a system for delivering a product ordered by a user, there is known a technique for calculating a delivery fee according to products in a case where a plurality of orders are made by one user (for example, see Patent document

### CITATION LIST

### Patent Document

[Patent document 1] Japanese Patent Laid-Open No. 2002-216041

### SUMMARY

The present disclosure has its eject to perform efficient re-delivery of a package in a case where a package is not handed over when the package delivered.

An aspect of the present disclosure is an information processing apparatus including a controller configured to: detect failure to hand over a package by delivery of the package by a first vehicle in which the package that is scheduled to be delivered to a delivery destination is loaded; and perform matching, with the first vehicle, in a case where failure to hand over the package is detected, of a second vehicle that is different from the first vehicle and for which a condition allowing reloading of the package from the first; vehicle and a condition allowing delivery of the package to the delivery destination are established, where matching is performed on a basis of information about traveling of the first vehicle, information about the package, and information about traveling of the second vehicle.

An aspect of the present disclosure is an information processing method including: detecting failure to hand over a package by delivery of the package by a first vehicle in which the package that is scheduled to be delivered to a delivery destination is loaded; and performing matching, with the first vehicle, in a case where failure to hand over the package is detected, of a second vehicle that is different from the first vehicle and for which a condition allowing reloading of the package from the first vehicle and a condition allowing delivery of the package to the delivery destination are established, where matching is performed on a basis of information about traveling of the first vehicle, information about the package, and information about traveling of the second vehicle.

An aspect of the present disclosure is a program for causing a computer to: detect failure to hand over a package by delivery of the package by a first vehicle in which the package that is scheduled to be delivered to a delivery destination is loaded; and perform matching, the first vehicle, in a case where failure to hand over the package is detected, of a second vehicle that is different from the first vehicle and for which a condition allowing reloading of the package from the first vehicle and a condition allowing delivery of the package to the delivery destination are established, where matching performed on a basis of information about traveling of the first vehicle, information about the package, and information about traveling of the second vehicle.

According to the present disclosure, re-delivery of a package may be performed efficiently in a case where the package is not handed over when the package is delivered.

### BRIEF DESCRIPTION OF THE DRAWINGS

FIG. 1 is a diagram illustrating a schematic configuration of a delivery system according to an embodiment;

FIG. 2 is a block diagram schematically illustrating an example configuration of each of a user terminal and a server forming a delivery system according to a first embodiment;

FIG. 3 is a diagram illustrating a functional configuration of the server;

FIG. 4 is a diagram illustrating a table structure of package information;

FIG. 5 is a diagram illustrating a table structure of vehicle information;

FIG. 6 is a diagram illustrating a functional configuration of the user terminal;

FIG. 7 is an example of a flowchart of a first matching process according to the first embodiment;

FIG. 8 is an example of a flowchart of a process for generating a travel route of a first vehicle (a travel route generating process);

FIG. 9 is an example of a flowchart of a second matching process according to the first embodiment;

FIG. 10 is an example of a flowchart of a process for generating a travel route of a second vehicle (a travel route generating process);

FIG. 11 is a diagram illustrating the travel routes of the first vehicle and the second vehicle in a simplified manner;

FIG. 12 is a diagram illustrating a sequence of processes by the delivery system according to the first embodiment;

FIG. 13 is a diagram illustrating a sequence of processes by a delivery system according to a second embodiment;

FIG. 14 is an example of a flowchart of a second matching process according to the second embodiment;

FIG. 15 is a diagram illustrating a functional configuration of a user terminal according to a third embodiment;

FIG. 16 is an example of a flowchart of a second matching process according to the third embodiment; and

FIG. 17 is a diagram illustrating a sequence of processes by a delivery system according to the third embodiment.

### DESCRIPTION OF THE EMBODIMENTS

As a mode of using one vehicle by a plurality of users, a mode of carrying packages by using an available space in a vehicle is conceivable, in addition to a mode of sharing a ride n the vehicle by the plurality of users. An information processing apparatus as a mode of the present disclosure performs matching of a second vehicle which is capable of receiving a package from a first vehicle and of delivering the package to a delivery destination, after the first vehicle fails to hand over of the package at the delivery destination. Matching here is to set a combination of vehicles for delivering a package. Alternatively, a combination of a vehicle and a user may be set, or a combination of users may be set by the matching. Matching is performed in such a way that a package may be handed over from the first vehicle to the second vehicle. Any vehicle which is scheduled to travel through locations that are relatively close to a travel route of the first vehicle, or any vehicle, a travel route of which intersects the travel route of the first vehicle, may relatively easily receive a package from the first vehicle. Accordingly, if the second vehicle is such a vehicle, a condition allowing reloading of a package from the first vehicle to the second vehicle may be determined as established. Furthermore, matching is performed in such a way that the second vehicle is able to deliver a package to the delivery destination. Any vehicle which is scheduled to travel through locations that are relatively close to the delivery destination may easily deliver a package to delivery destination. Accordingly, if the second vehicle s such a vehicle, a condition allowing delivery of a package to the delivery destination by the second vehicle may be determined as established. A second vehicle for which both of the conditions are established is matched with the first vehicle. Such matching enables the second vehicle to receive and deliver a package which the first vehicle failed to hand over. Moreover, if the first vehicle is to head again to the delivery destination to perform delivery, a movement distance of the package is possibly increased, resulting in low efficiency. By reloading the package from the first vehicle to the second vehicle, the travel distance of the package is reduced, and efficiency for re-delivery may be increased. Furthermore, because the first vehicle does not have to return to the delivery destination, unnecessary traveling may be reduced for the first vehicle.

Information about traveling of the first vehicle is information regarding the travel route of the first vehicle, for example. The information about traveling of the first vehicle includes a current position, a destination at the time of traveling (a travel destination), and a traveling period, for example. Information about traveling of the second vehicle is information regarding the travel route of the second vehicle, for example. The information about traveling of the second vehicle includes a current position, a destination at the time of traveling travel destination), and a traveling period, for example. Information about movement of a package is information used in delivering the package, for example. The information about movement of a package includes a source location, a destination at the time of delivery (a delivery destination), and a delivery period, for example. The condition allowing reloading of a package from the first vehicle to the second vehicle is that the travel route of the first vehicle and the travel route of the second vehicle intersect each other, or that a distance between a part of the travel route of the first vehicle and a part of the travel route of the second vehicle is within an allowable range, for example. Furthermore, the condition allowing delivery of a package to the delivery destination by the second vehicle is that the delivery destination is along the travel route of the second vehicle, or that a distance from a part of the travel route of the second vehicle to the delivery destination is within an allowable range, for example.

Furthermore, the controller may determine that the condition allowing reloading of the package from the first vehicle to the second vehicle is established, in a case where the second vehicle is scheduled to move through a location within a first predetermined range of any of locations on a route, between the delivery destination and a first travel destination that is a de in n of the first vehicle, along which the first vehicle is scheduled to travel.

For example, the first predetermined range is a range in which burdens on drivers of the first vehicle and the second vehicle are within an allowable range even when the travel routes of the vehicles are changed. By performing matching of a second vehicle which allows reloading of the package from the first vehicle to the second vehicle at a location within such a first predetermined range, burdens on the drivers of the two vehicles may be reduced. A burden on a driver may be a temporal burden, a cost burden, or the like, for example.

Furthermore, the controller may determine that the condition allowing delivery of the package to the delivery destination by the second vehicle is established, in a case where the second vehicle is scheduled to move through a location within a second predetermined range of the delivery destination after moving through a location within the first predetermined range.

For example, the second predetermined range is a range in which a burden on the driver of the second vehicle is within an allowable range even when the travel route of the second vehicle is changed. If the delivery destination is at a location within such a second predetermined range, the travel route of the second vehicle does not have to be greatly changed, and a burden on the driver of the second vehicle may be reduced.

Furthermore, the controller may acquire information about a delivery period that is a period when delivery of the package by the second vehicle is desired by a user who is to receive the package at the delivery destination, and determine, in a case where the information about the delivery period is acquired, that the condition allowing delivery of the package to the delivery destination by the second vehicle is established, in a case where the second vehicle is scheduled to move, in the delivery period, through a location within a second predetermined range of the delivery destination after moving through a location within the first predetermined range.

By causing a period when the package is to be re-delivered to be the period desired by a user who is to receive the package, the package may be more reliably delivered by the second vehicle. This enables re-delivery of a package to be performed more efficiently.

Furthermore, the controller may set a hand-over location where the package is reloaded from the first vehicle to the second vehicle, within the first predetermined range of any of locations on the route, between the delivery destination and the first travel destination, along which the first vehicle is scheduled to travel, and transmit information about the hand-over location to a terminal corresponding to the first vehicle and a terminal corresponding to the second vehicle.

The hand-over location is a location that is set within the first predetermined range of any of locations on the route along which the first vehicle is scheduled to travel, and is a location that is easily accessed by both the first vehicle and the second vehicle. By setting such a location, and then, transmitting information about the hand-over location to a terminal corresponding to the first vehicle and a terminal corresponding to the second vehicle, the first vehicle and the second vehicle may be caused to travel via the hand-over location. A package may thereby be handed over from the first vehicle to the second vehicle at the hand-over location. Additionally, the first vehicle and the second vehicle do not have to be present at the hand-over location at a same time. For example, the first vehicle may leave a package at the hand-over location, and then, the second vehicle may come to retrieve the package. In this case, a shop or a warehouse for temporarily keeping packages may be present at the hand-over location.

Furthermore, the controller may provide information about each of a plurality of the second vehicles to a terminal corresponding to a user who is to receive the package at the delivery destination, in a case where there are a plurality of the second vehicles for which the condition allowing reloading of the package from the first vehicle and the condition allowing delivery of the package to the delivery destination are established, acquire, from the terminal corresponding to the user, information about one second vehicle selected by the user from the plurality of the second vehicles, and perform matching between the first vehicle and the one second vehicle.

There are sometimes a plurality of second vehicles which are capable of delivering a package to a delivery destination. In such a case, if a user who is to receive the package is allowed to select one second vehicle from the plurality of second vehicles, the user may receive the package by a desired delivery mode. The information about each of the second vehicles to be provided to the user is information allowing the user to select a second vehicle, and is user information or a traveling period of each of the second vehicles, for example. The information about one second vehicle is information allowing identification of the vehicle selected by the user.

In the following, embodiments of the present disclosure will be described with reference to the drawings. Configurations of the following embodiments are exemplary, and the present disclosure is not limited to the configurations of the embodiments. Furthermore, the following embodiments may be combined in any possible way.

### First Embodiment

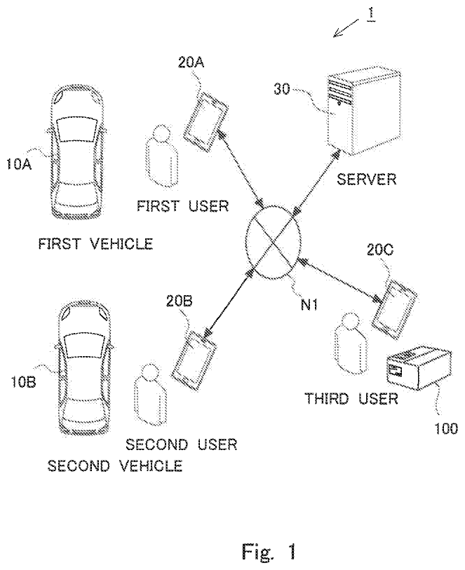

FIG. 1 is a diagram illustrating a schematic configuration of a delivery system 1 according to an embodiment. In the example in the delivery system 1 includes a first vehicle 10A that is driven by a first user, a first user terminal 20A that is used by the first user, a second vehicle 10 that is driven by a second user, a second user terminal 20B that is used by the second user, a third user terminal 20C that is used by a third user, and a server 30. Additionally, the third user is a user who wants a package 100 to be delivered to a delivery destination. Furthermore, the first user and the second user are users who are registered in the server 30 as users who are to transport the package 100. The first user is a user who first transports the package 100 to the delivery destination The second user is a user who receives the package 100 from the first user and transports the package 100 to the delivery destination again, in a case where the first user failed to hand over the package 100 to the third user at the delivery destination. There are a plurality of first users, second users, and third users. There are the same numbers of the first user terminals 20A and the first vehicles 10A as the number of the first users who use the delivery system 1, the same numbers of the second user terminals 20B and the second vehicles 10B as the number of the second users who use the delivery system 1, and the same number of the third user terminals 20C as the number of the third users who use the delivery system 1.

In the following, in the case where the first vehicle 10A and the second vehicle 10B do not have to be distinguished from each other, a term “vehicle(s) 10” will be simply used. Furthermore, in the case where the first user terminal 20A, the second user terminal 20B, and the third user terminal 20C do not have to be distinguished from one another, a term “user terminal(s) 20” will be simply used. In the case where the first user, the second user, and the third user do not have to be distinguished from one another, a term “use (s)” will be simply used. The user terminal 20 and the server 30 are connected to each other over a network N1. For example, as the network N1, a wide area network (WAN), which is a worldwide public communication network such as the Internet, or other communication networks may be adopted. Furthermore, the network N1 may include a mobile communication network for mobile phones, or a wireless communication network such as Wi-Fi.

The delivery system 1 performs matching in such a way that the package 100 of the third user is delivered by the first vehicle 10A, and generates a travel route of the first vehicle 10A in such a way that the matched package 100 can be delivered to the delivery destination. Matching here is to set a combination of the package 100 and the first vehicle 10A that is to deliver the package 100. Alternatively, a combination of the first vehicle 10A and the third user, or a combination of the first user and the third user, or a combination of the first user and the package 100 may be set by the matching. The generated travel route is transmitted to the first user terminal. 20A and the third user terminal 20C.

Additionally, the first user terminal 20A may simply display the received travel route on a map, or may guide a traveling direction of the first vehicle 10A according to the received travel route.

The third user may load the package 100 on the first vehicle 10A at a source location of the package 100. For example, in this case, after loading the package 100 on the first vehicle 10A at the source location of the package 100, the third user travels to the delivery destination by means different from the first vehicle 10A, and receives the package 100 at the delivery destination. Alternatively, at the source location of the package 100, a third person different from the third user may load the package 100 on the first vehicle 10A. For example, in a case where the third user purchases a product from a seller and wishes the product to be delivered, the seller may load the package 100 on the first vehicle 10A at the source location of the package 100.

Furthermore, in a case where the delivery of the package 100 to the third user by the first vehicle 10A fails (such as in a case of absence of the third user), information indicating such a situation is transmitted from the first user terminal 20A to the server 30. Then, the server 30 performs matching between the first vehicle 10A and the second vehicle 10B in such a way that the package 100 may be reloaded from the first vehicle 10A to the second vehicle 10B. The second vehicle 10B is a vehicle which is capable of delivering the package 100 to the delivery destination. When the is complete, a travel route of the second vehicle 10B is generated in such a way that the package 100 may be received he first vehicle 10A and the package 100 may be delivered to the delivery destination. The travel route is transmitted to the second user terminal 20B and the third user terminal 20C. The second user terminal 20B may simply display the received travel route on a map, or may guide a traveling direction of the second vehicle 10B according to the received travel route. Additionally, the present embodiment may also be applied to a vehicle which is autonomously driven (hereinafter referred to as “autonomous vehicle”). In this case, there are no first user and second user, and the first user terminal 20A is a terminal that is installed in the first vehicle 10A, and the first user terminal 20A causes the first vehicle 10A to travel along the travel route. The second user terminal 20B is a terminal that is installed in the second vehicle 10B, and the second user terminal 20B causes the second vehicle 10B to travel along the travel route.

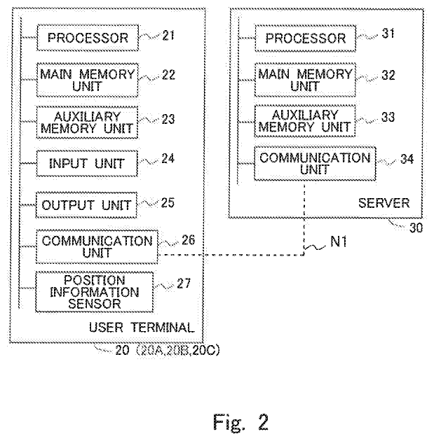

Hardware configurations of the user terminal 20 and the server 30 will be described with reference to FIG. 2. FIG. 2 is a block diagram schematically illustrating an example of a configuration of each of the user terminal 20 and the server 30 forming the delivery system 1 according to the present embodiment.

The server 30 has a configuration of a general computer. The server 30 includes a processor 31, a main memory unit 32, an auxiliary memory it 33, and a communication unit 34. These are interconnected by a bus.

The processor 31 is a central processing unit (CPU), a digital signal processor (DSP), or the like. The processor 31 controls the server 30 and performs calculation for various types of information processing. The processor 31 is an example of “controller”. The main memory unit 32 is a random access memory (RAM), a read only memory (ROM), or the like. The auxiliary memory unit 33 is an erasable programmable ROM (EPROM), a hard disk drive (HDD), a removable medium, or the like. An operating system (OS), various programs, various tables and the like are stored in the auxiliary memory unit 33 The processor 31 loads a program stored in the auxiliary memory unit 33 into a work area of the main memory unit 32 and executes the program, and each structural unit or the like is controlled through execution of the program. A function matching a predetermined object is thereby implemented by the server 30. The main memory unit 32 and the auxiliary memory unit 33 are computer-readable recording media. Additionally, the server 30 may be single computer, or may be a plurality of computers operating in coordination. Furthermore, information to be stored in the auxiliary memory unit 33 may be stored in the main memory unit 32. Information to be stored in the main memory unit 32 may be stored in the auxiliary memory unit 33

The communication unit 34 is means for performing communication with the user terminal 20 over the network N1. For example, the communication unit 34 is a local area network (LAN) interface board, or a wireless communication circuit for wireless communication. The LAN interface board or the wireless communication circuit is connected to the network N1.

Additionally, a series of processes to be performed by the server 30 may be performed by hardware or by software. The hardware configuration of the server 30 is not limited that illustrated in FIG. 2.

Next, a description will be given of the user terminal 20. For example, the user terminal 20 is a small computer such as a smartphone, a mobile phone, a tablet terminal, a personal di al assistant, a wearable computer (such as a smartwatch), or a personal computer (PC). Additionally, the first user terminal 20A may be a terminal that is installed in the first vehicle 10A. Furthermore, the second user terminal 20B may be a terminal that is installed in the second vehicle 10B. The user terminal 20 includes a processor 21, a main memory unit 22, an auxiliary memory unit 23, an input unit 24, an output unit 25, a communication unit 26, and a position informati sensor 27. These are interconnected by a bus. The processor 21, the main memory unit 22, and the auxiliary memory unit 23 are the same as the processor the main memory unit 32, and the auxiliary memory unit 33 of the server 30, and a description thereof is omitted. Additionally, the user terminal 20 may be single computer, or may be a plurality of computers operating in coordination. For example, the first user terminal 20A may be implemented by coordination of a computer installed in the first vehicle 10A and a computer carried by the first user. Furthermore, for example, the second user terminal 20B may be implemented by coordination of a computer installed in the second vehicle 10B and a computer carried by the second user.

The input unit 24 is means for receiving an input operation performed by a user, and is a touch panel, a push button, or the like, for example. The output unit 25 is means for presenting information to a user, and is a liquid crystal display (LCD), an electroluminescence (EL) panel, a speaker, a lamp, or the like, for example. The input unit 24 and the output unit 25 may be formed as one touch panel display. The communication unit 26 is communication means for connecting the user terminal 20 to the network N1. The communication unit 26 is a circuit for performing communication with other apparatuses (such as the server 30) over the network N1, by using a mobile communication service (such as a telephone communication network such as 3rd Generation (3G) or Long Term Evolution (LTE), or wireless communication such as Wi-Fi), for example.

The position information sensor 27 acquires position information of the user terminal 20 every predetermined period. For example, the position information sensor 27 is a global positioning system (GPS) receiver, a Wi-Fi communication unit, or the like. Additionally, the hardware configuration of the user to 20 is not limited to that illustrated in FIG. 2.

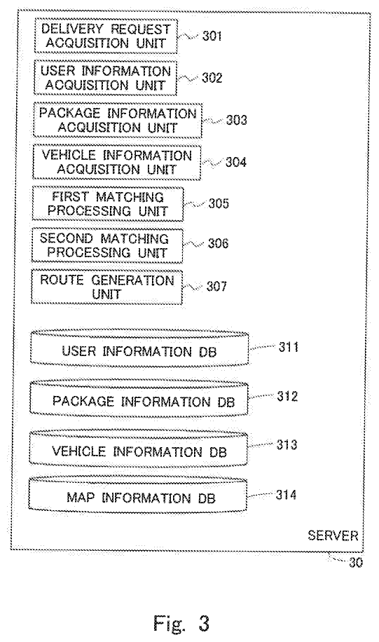

Next, a function of the server 30 will be described. FIG. 3 is a diagram illustrating a functional configuration of the server 30. As functional structural elements, the server 30 includes a delivery request acquisition unit a user information acquisition unit 302, a package information acquisition unit 303, a vehicle information acquisition unit 304, a first matching processing unit 305, a second matching processing unit 306, a route generation unit 307, a user information DB 311, a package information DB 312, a vehicle information DB 313, and a map information DB 314. The processor 31 of the server 30 performs, by computer programs in the main memory unit 32, processes by the delivery request acquisition unit 301, the user information acquisition unit 302, the package information acquisition unit 303, the vehicle information acquisition unit 304, the first matching processing unit 305, the second matching processing unit 306, and the route generation unit 307. Alternatively, any of the functional structural elements or a part of the processes may be implemented by a hardware circuit.

The user information DB 311, the package information DB 312, the vehicle information DB 313, and the map information DB 314 are structured by management of data, stored in the auxiliary memory unit 33, by programs of a database management system (DBMS) executed by the processor 31. For example, the user information DB 311, the package information DB 312, the vehicle information DB 313, and the map information DB 314 are relational databases.

Additionally, any of the functional structural elements of the server 30, or a part of the processes may be implemented by another computer which is connected to the network N1.

For example, the delivery request acquisition unit 301 acquires a delivery request from the third user terminal 20C of a third user who wishes for delivery of a package 100. The delivery request is information including an identifier of the third user, and is information for requesting or matching between the package 100 of the third user and the first vehicle 10A of a first user.

Furthermore, the user information acquisition unit 302 acquires information about a user e., user information) corresponding to a respective user terminal 20, for example. The user information includes a user ID, a name, and an address associated with a user, and in the case of a driver of a vehicle 10, the user information includes a model or a color of the vehicle, a license number of the vehicle, capacity of the vehicle, and the like. The user ID is a unique identifier of a user. The user information is transmitted from the user terminal 20 to the server 30, and is registered in the server 30. When the user information is acquired, the user information acquisition unit 302 stores the user information in the user information DB 311 described later.

The package information acquisition unit 303 acquires information about a package 100 (hereinafter referred to also as “package information”). The package information is information that is transmitted from third user terminal 20C to the server 30, together with the delivery request, and includes information about a source location, a delivery destination, and a delivery period of the package 100. When the package information is acquired, the package information acquisition unit 303 stores the package information in the package information DB 312 described later.

The vehicle information acquisition unit 304 acquires information about traveling of the vehicle 10 (hereinafter referred to also as “vehicle information”). The vehicle information pieces are information pieces that are transmitted from the first user terminal 20A and the second user terminal 20B to the server 30, and include information about current positions of the first vehicle 10A and the second vehicle 10B, travel destinations, and traveling periods. When the vehicle information acquired, the vehicle information acquisition unit 304 stores the vehicle information in the vehicle information DB 313 described later.

The first matching processing unit 305 performs matching between the first vehicle 10A and the package 100. Any known technique may be used as the method of matching. In a delivery period of the package 100, the first matching processing unit 305 searches for a first vehicle 10A which includes, within a predetermined range of a scheduled traveling route of the first vehicle 10A, the source location of the package 100 and the delivery destination of the package 100. The predetermines range here is a range where a burden on the first user remains within an allowable range even when the first vehicle 10A changes the travel route, and is within a same municipal area, for example. The scheduled travel route is generated on the basis of a current position and a travel destination of the first vehicle 10A or the first user) and map information that stored in, the map information DB 314. Additionally, a matching process by the first matching processing unit 305 will be hereinafter referred to as “first matching process”.

The second matching processing unit 306 performs matching between the first vehicle 10A and the second vehicle 10B. In the delivery period of the package 100, the second matching processing unit 306 searches for a second vehicle 10B which includes, within a predetermined range of a scheduled traveling route of the second vehicle 10, both a location on the travel route, of the first vehicle 10A, between the delivery destination of the package 100 and the travel destination of the first vehicle 10A (hereinafter, such a location will be referred to as “hand-over location”) and the delivery destination of the package 100. Additionally, the predetermined range here is a range where a burden on the second user remains within an allowable range even when the second vehicle 10B changes the travel route, and is within a same municipal area, for example. The predetermined range may be the same as or different from the predetermined range in the first matching process. The scheduled travel route is generated on the basis of a current position and a travel destination of the second vehicle 10B (or the second user) and the map information that is stored in the map information DB 314. Additionally, a matching process by the second matching processing unit 306 will be hereinafter referred to as “second matching process”.

The route generation unit 307 generates a travel route of the first vehicle 10A, matched by the first matching process, that passes through the current position of the first vehicle 10A, the source location of the package 100, the delivery destination of the package 100, and the travel destination of the first vehicle 10A in this order. The travel route is generated on the basis of the map information that is stored in the map information DB 314. A route that is in accordance with a predetermined rule, such as a route by which a travel distance of the first vehicle 10A is the shortest or a route by which a travel time of the first vehicle 10A is the shortest, is generated as the travel route. The route generation unit 307 transmits the generated travel route to the first user terminal 20A of the first user. Furthermore, in the case where the first vehicle 10A and the second vehicle 10B are matched by the second matching process, the route generation unit 307 generates the travel route for each of the first vehicle 10A and the second vehicle 10B. The travel route of the first vehicle 10A is generated in such a way that the travel route passes through the current position of the first vehicle 10A, the hand-over location, and the travel destination of the first vehicle 10A in this order. Furthermore, the travel route of the second vehicle 10B is generated in such a way that the travel route passes through the current position of the second vehicle 10B, the hand-over location, the delivery destination, and the travel destination of the second vehicle 10B in this order. Routes that are in accordance with a predetermined rule, such as routes by which travel stances of the first vehicle 10A and the second vehicle 10B are the shortest or routes by which travel times of the first vehicle 10A and the second vehicle 10B are the shortest, are generated as respective travel routes. The route generation unit 307 transmits the generated travel routes to the first user terminal 20A of the first user, and the second user terminal 20B of the second user. Additionally, in the case where the hand-over location is set on the travel route of the first vehicle 10A, the travel route of the first vehicle 10A does not have to be generated again. Furthermore, in the first matching process, the route generation unit 307 generates a scheduled travel route of the first vehicle 10A in such a way that the scheduled travel route passes through the current position of the first vehicle 10A and the travel destination of the first vehicle 10A in this order. The generated scheduled travel route of the first vehicle 10A is transferred to the first matching processing unit 305. Moreover, the route generation unit 307 generates, in the second matching process, a scheduled travel route of the second vehicle 10B in such a way t the scheduled travel route passes through the current position of the second vehicle 10B and the travel destination of the second vehicle 10B in this order. The generated scheduled travel route of the second vehicle 10B is transferred to the second matching processing unit 306.

The user information DB 311 is formed by storing the user information in the auxiliary memory unit 33 described above, and a user and the user information are associated with each other in the database.

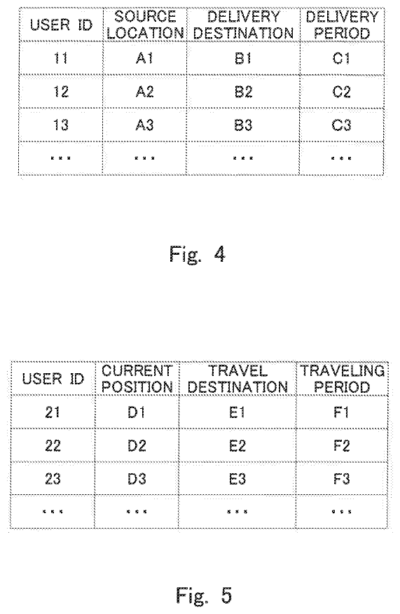

The package information DB 312 is formed by storing the package information in the auxiliary memory unit 33 described above, and the third user and the package information are associated with each other in the database. A structure of the package information that is stored in the package information DB 312 will be described below with reference to FIG. 4. FIG. 4 is a diagram illustrating a table structure of the package information. A package information table includes fields of a user ID, a source location, a delivery destination, and a delivery period. Identification information for specifying the third user is input in the user ID field. Information indicating the source location of the package 100 is input in the source location field. Additionally, the source location of the package 100 may be a current position of the package 100, or may be a location where the package 100 is desired to be loaded on the first vehicle 10A. Furthermore, information indicating the delivery destination where the package 100 is to be delivered is input in the delivery destination field. The source location and the delivery destination of the package 100 are each expressed in latitude and longitude, for example. Information indicating a time period when the package 100 is desired to be delivered is input in the delivery period field.

The vehicle information DB 313 is formed by storing the vehicle information in the auxiliary memory unit 33 described above, and the vehicle information is associated with the first user and the second user in the database. A structure of the vehicle information that is stored in the vehicle information DB 313 will be described below with reference to FIG. 5. FIG. 5 is a diagram illustrating a table structure of the vehicle information. The vehicle information table includes fields of a user ID, a current position, a travel destination, and a travel period. Identification information pieces for identifying the first user and the second user are input in the user ID fields. Information pieces indicating current positions of the vehicles 10 or current positions of the first user and the second user) are input in the current position fields Information pieces indicating final destinations when the vehicles 10 travel are input in the travel destination fields. The current position and the travel destination of the vehicle 10 are each expressed in latitude and longitude, for example. Information indicating a time period when the vehicle 10 travels is input in the travel period field. Additionally, the vehicle information that is stored in the vehicle information DB 313 does not distinguish between the first vehicle 10A and the second vehicle 10B. That is, the first vehicle 10A and the second vehicle 10B are not distinguished from each other from the start, and the vehicle 10 that is matched with the pa e 100 in the first matching process becomes the first vehicle 10A, and the vehicle 10 that is matched with the first vehicle 10A in the second matching process becomes the second vehicle 10B.

The map information DB 314 stores, as the map information, link data related to roads (links), node data related to node points, intersection data related to each intersection, search data for searching for a route, facility data related to facilities, search data for searching for a location, and the like.

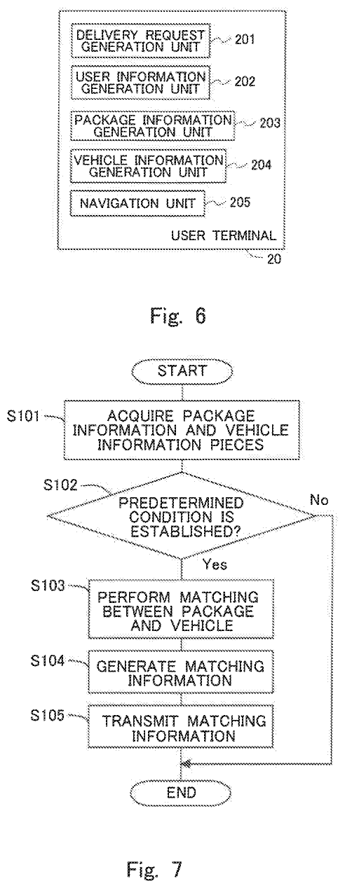

Next, a function of the user terminal 20 will be described. FIG. 6 is a diagram illustrating a functional configuration of the user terminal 20. The user terminal 20 includes, as functional structural elements, a delivery request generation unit 201, a user information generation unit 202, a package information generation unit 203, a vehicle information generation unit 204, and a navigation unit 205. The processor 21 of the user terminal 20 performs, by computer programs in the main memory unit 22, processes by the delivery request generation unit 201, the user information generation unit 202, the package information generation unit 203, the vehicle information generation unit 204, and the navigation unit 205. Alternatively, any of the functional structural elements or a part of the processes may be implemented by a hardware circuit.

The delivery request generation unit 201 displays an operation screen on the output unit 25, and generates a delivery request in response to an input on the input unit 24 by the third user. The delivery request generation unit 201 is a functional structural element that operates in the third user terminal 20C. For example, the delivery request generation unit 201 outputs, on a touch panel display, an icon or the like for issuing a delivery request, and generates the delivery request in a case where the third user clicks the icon. The delivery request generation unit 201 transmits the generated delivery request to the server 30, in association with the user ID.

The user information generation unit 202 generates the user information. The user information generation unit 202 is a functional structural element that operates in each of the first user terminal 20A, the second user terminal 203, and the third user terminal 20C. The user information generation unit 202 displays, on the output unit 25, an operation screen for urging input of user information, and generates user information according to an input on the input unit 24 by the user. The generated user information is transmitted to the server 30 by the user information generation unit 202. Additionally, the user information may be input in advance by the user using the input unit 24, and be stored in the auxiliary memory unit 23 of the user terminal 20. The user information generation unit 202 may then generate the user information on the basis of the data stored in the auxiliary memory unit 23. Furthermore, for example, the user information generation unit 202 may generate the user information at a time of each user performing user registration, and may transmit the user information to the server 30. In this case, the user information is stored in advance in the user information DB 311 of the server 30.

The package information generation unit 203 generates the package information of the package 100. The package information generation unit 203 is a functional structural element that operates in the third user terminal 20C. The package information generation unit 203 displays, on the output unit 25, an operation screen for urging input of package information, and generate package information according to an input on the input unit 24 by the third user. The generated package information is transmitted to the server 30 by the package ion generation unit 203. Additionally, the package information may be input in advance by the third user using the input unit 24, and may be stored in the auxiliary memory unit 23 of the third user terminal 20C. The package information generation unit 203 may then generate the package information on the basis of the data stored in the auxiliary memory unit 23.

The vehicle information generation unit 204 generates vehicle information of the vehicle 10. The vehicle information generation unit 204 is a functional structural element that operates in the first user terminal 20A and the second user terminal 20B. For example, the vehicle information generation unit 204 displays, on the output unit 25, an operation screen for urging input of vehicle information, and generates vehicle information according to an input on the input unit 24 by the first user or the second user. The first user and the second user may simply input travel destinations. The vehicle information generation unit 204 may detect the current position of the first user terminal 20A or the second user terminal 20B on the basis of the position information detected by the position information sensor 27, and may take the current position as the current position of the first vehicle 10A or the second vehicle 10B. The generated vehicle information is transmitted to the server 30 by the vehicle information generation unit 204. Additionally, the vehicle information may be input by the first user or the second user through the input unit 24 in advance, and may be stored in the auxiliary memory unit 23 of the first user terminal 20A or the second user terminal 20B. The vehicle information generation unit 204 may then generate the vehicle information on the basis of the data stored in the auxiliary memory unit 23. Alternatively, the vehicle information generation unit 204 may transmit, to the server 30, information about the current position, together with the user ID, from the first user terminal 20A or the second user terminal 20B every predetermined period of time (such as 60 seconds). The server 30 which received the information about the current position updates the current position field in the vehicle information DB 313.

The navigation unit 205 displays, on the output unit 25, a map of a periphery of the current position of the user terminal 20 (or the current position of the vehicle 10), on the basis of the map information stored in the auxiliary memory unit 23, for example. Furthermore, when a travel route is received from the server 30, the navigation unit 205 guides a route according to the received travel route. At this time, the navigation unit 205 outputs the travel route on the output unit 25 The navigation unit 205 causes the map and the travel route to be displayed on a display, or guides a traveling direction by audio according to the travel route, for example. Any known technique may be used with respect to the function of the navigation unit 205.

Additionally, in the delivery system 1, the travel route is generated by the route generation unit 307 of the server 30, but generation of the travel route may alternatively be performed by the navigation unit 205 of the user terminal 20. In this case, the server 30 transmits the vehicle information and the package information, respectively, of the vehicle 10 and the package 100 which are matched, to the user terminals 20 of the users corresponding to the vehicle 10 and the package 100 which are matched. Then, the navigation unit 205 generates the travel route on the basis of the vehicle information, the package information, and the map information that is stored in the auxiliary memory unit 23. The map information that is stored in the auxiliary memory unit 23 is information equivalent to the map information that is stored in the map information. DB 314 of the server 30.

Next, a description will be given of the first matching process that is performed by the first matching processing unit 305 at the server 30. FIG. 7 is an example of a flowchart of the first matching process according to the present embodiment. The first matching process illustrated in FIG. 7 is performed for a third user who transmitted a delivery request from third user terminal 20C. The first matching process is performed by checking the package information that is stored in the package information DB 312 and the vehicle information that is stored in the vehicle information DB 313 against each other. Additionally, it is assumed here that the server 30 receives beforehand the user information of the first user and the vehicle information of the first vehicle 10A from the first user terminal 20A, and the user information of the third user and the package information from the third user terminal 20C.

In step S101, package information corresponding to a third user who transmitted a delivery request, among package information pieces stored in the package information DB 312, and one vehicle information piece among vehicle information pieces stored in the vehicle information DB 313 are acquired. Next, in step S102, whether or not a predetermined condition allowing delivery of the package 100 by the first vehicle 10A to the delivery destination is established is determined on the basis of the package information and the vehicle information acquired in step S101. The “predetermined condition” here is a condition for determining whether or not the first vehicle 10A may relatively easily receive the package 100, and whether or not the package 100 may be relatively easily delivered to the delivery destination by the first vehicle 10A. Specifically, the first matching processing unit 305 determines that the predetermined condition is established, in a case where both the source location of the package 100 and the delivery destination of the package 100 are within a predetermined range of the scheduled travel route of the vehicle 10A in the delivery period of the package 100. The scheduled travel route is generated on the basis of the current position and the travel destination of the first vehicle 10A, and the map information that is stored in the map information DB 314. That is, the delivery period of the package 100 and the traveling period of the first vehicle 10A are the same, the package 100 may be delivered by the first vehicle 10A in a period when delivery is desired by the third user. Furthermore, if both the source location of the package 100 and the delivery destination of the package 100 are within the predetermined range of the scheduled travel route of the first vehicle 10A, a change that is made in the travel route of the first vehicle 10A is relatively small, and a burden on the first user is small. In the case where an affirmative determination is made in step S102, step S103 is performed next, and in the case where a negative determination is made, it can be determined that matching is not established between the package 100 and the first vehicle 10A acquired in the current step S101, and the present flowchart is temporarily ended.

Next, in step S103, the package 100 according to the package information acquired in the current step S101 and the first vehicle 10A according to the one vehicle information piece acquired in the current step S101 are matched with each other. Next, in step S104, matching information pieces to be transmitted to the third user terminal 20C corresponding to the package 100 matched in step S103 and the first user terminal 20A corresponding to the first vehicle 10A matched in step S103 are generated. The matching information to be transmitted to the first user terminal 20A is generated as information including the package information of the package 100, and the user information (such as a name) of the third user. For its part, the matching information to be transmitted to the third user terminal 200 is generated as information including the user information of the first user. The matching information pieces generated in step S104 are transmitted in step S105 to the first user terminal 20A and the third user terminal 200. Then, the process illustrated in FIG. 7 is ended, Additionally, in the case where a negative determination is made in step S102, the first matching processing unit 305 performs the process illustrated in FIG. 7 again, and at this time, acquires, in step S101, vehicle information that is different from the previous information as the vehicle information of the first vehicle 10A. Then, the first matching processing unit 305 repeatedly performs the process illustrated in FIG. 7 until an affirmative determination is made in step S102. In the case where matching is not performed between the first vehicle 10A and the package 100 even when the first matching process is repeatedly performed by the first matching processing unit 305, information indicating failure of matching with the first vehicle 10A is generated, and is transmitted to the third user terminal 20C.

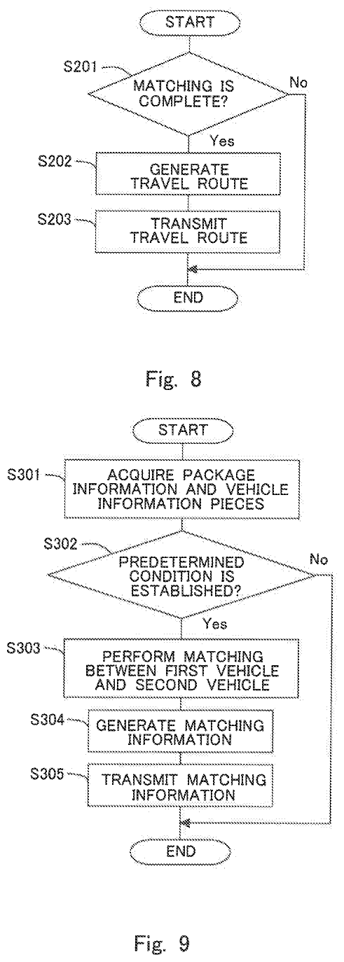

FIG. 8 is an example of a flowchart of a process for generating a travel route of the first vehicle 10A (a travel route generating process). The present flowchart is performed by the route generation unit 307 of the server 30 every predetermined period of time. Additionally, the flowchart illustrated in FIG. 8 may alternatively be performed subsequent to the first matching process illustrated in FIG. 7. In step S201, whether or not matching between the package 100 and the first vehicle 10A is completed by the first matching processing unit 305 is determined. In the case where an affirmative determination is made in step S201, step S202 is performed next, and in the case where a negative determination is made, the present flowchart is ended. In step S202, a travel route is generated in such a way that the package 100 matched in the first matching process may be delivered by the first vehicle 10A matched in the first matching process. That is, a travel route is generated in such a way that the first vehicle 10A passes through the current position of the first vehicle 10A, the source location of the package 100, the delivery destination of the package 100, and the travel destination of the first vehicle 10A in this order. Then, in step S203, the travel route is transmitted from the server 30 to the first user terminal 20A. Then, the process illustrated in FIG. 8 is ended.

Next, a case where the package 100 is not handed over at the time of delivery of the package 100 by the first vehicle 10A, due to absence of the third user, for example, will be described. In this case, the second matching processing unit 306 performs matching between the first vehicle 10A and the second vehicle 10B. FIG. 9 is an example of a flowchart of the second matching process according to the present embodiment. The second matching process illustrated in FIG. 9 is performed for the first vehicle 10A which failed to hand over the package 100. The second matching process is performed by checking, against one another, the package information stored in the package information DB 312, the vehicle information corresponding to the vehicle 10A stored in the vehicle information DB 313, and the vehicle information corresponding to the second vehicle 10B stored in the vehicle information DB 313. A request for re-delivery of the package 100 (hereinafter referred to also as “re-delivery request”) is transmitted from the first user terminal 20A corresponding to the first vehicle 10A. When the re-delivery request is received by the server 30, failure of the hand-over e package 100 to the third user by the first vehicle 10A is detected by the server 30. Then, the second matching process is performed. Additionally, it is assumed here that the server 30 receives beforehand the user information of the first user and the vehicle information of the first vehicle 10A from the first user terminal 20A, the user information of the second user and the vehicle information of the second vehicle 10B from the second user terminal 20B, and the user information of the third user and the package information from the third user terminal 20C.

In step S301, package information of the package 100 associated with the re-delivery request, among package information pieces stored in the package information DB 312, vehicle information associated with the first vehicle 10A corresponding to the first user terminal 20A which transmitted the re-delivery request, among vehicle information pieces stored in the vehicle information DB 313, and vehicle information which is one vehicle information piece among vehicle information pieces stored in the vehicle information. DB 313 and which is associated with the second vehicle 10B different from the first vehicle 10A are acquired.

Next, in step S302, whether or not a predetermined condition allowing delivery of the package 100 to the delivery destination by the second vehicle 103 is established is determined on the basis of the package information and the vehicle information pieces acquired in step S301. The “predetermined condition” here is a condition for determining whether or not the second vehicle 10B may relatively easily receive the package 100, and whether or not the package 100 may be relatively easily delivered to the delivery destination by the second vehicle 103. Specifically, the second matching processing unit 306 determines that the predetermined condition is established, in a case where both a location (a hand-over location) on the travel route of the first vehicle 10A between the delivery destination of the package 100 and the travel destination of the first vehicle 100, and the delivery destination of the package 100 are within a predetermined range of the scheduled travel route of the second vehicle 10B in the delivery period of the package 100. The predetermined range here is a range where a burden on the second user remains within an allowable range even when the second vehicle 10B changes the travel route, and may be the same as or different from the predetermined range according to the first matching process. The scheduled travel route is generated on the basis of the current position and the travel destination of the second vehicle 10B, and the map information that is stored in the map information DB 314. That is, if the delivery period of the package 100 and the traveling period of the second vehicle 10B are the same, the package 100 may be delivered by the second vehicle 10B in a period when delivery is desired the third user. Furthermore, if both the hand-over location and the delivery destination of the package 100 are within the predetermined range of the scheduled travel route of the second vehicle 10B, a change that is made in the travel route of the second vehicle 10B is relatively small, and a burden on the second user is small. In the case where an affirmative determination is made in step S302, step S303 is performed next, and in the case where a negative determination made, it can be determined that matching is not established between the package 100, the first vehicle 10A, and the second vehicle 10B acquired in the current step S301, and the present flowchart is temporarily ended.

Next, in step S303, the package 100 according to the package information acquired in the current step S301, the first vehicle 10A according to the vehicle information acquired in the current step S301, and the second vehicle 10B according to the one vehicle information piece acquired in the current step S301 are matched with one another. Next, in step S304, matching information pieces to be trans: ted to the third user terminal 20C corresponding to the package 100 matched in step S303, the first user terminal 20A corresponding to the first vehicle 10A matched in step S303, and the second user terminal 20B corresponding to the second vehicle 10B matched in step S303 are generated. The matching information to be transmitted to the first user terminal 20A is generated as information including the user information (such as a name) of the second user. The matching information to be transmitted to the second user terminal 20B is generated as information including the package information corresponding to the package 100, and user information pieces of the first user and the third user. The matching information to be transmitted to the third user terminal 20C is generated as information including personal information of the second use r. Furthermore, the second matching processing unit 306 transmits information about the hand-over location of the package 100 to the user terminals 20, by including the information in the matching information. For example, the second matching processing unit 306 sets, as the hand-over location, any location on the scheduled travel route of the first vehicle 10A which is within the predetermined range of the scheduled travel route of the second vehicle 10B.

The matching information pieces generated in step S304 are transmitted to the user terminals 20 in step S305. Then, the process illustrated in FIG. 9 is ended. Additionally, in the case where a negative determination is made in step S302, the second matching processing unit 306 performs the process illustrated in FIG. 9 again, and at this time, acquires, in strep S301, vehicle information that is different from the previous information as the vehicle information of the second vehicle 103. Then, the second matching processing unit 306 repeatedly performs the process illustrated in FIG. 9 until an affirmative determination is made in step S302. In the case where matching is not performed between the first vehicle 10A and the second vehicle 103 even when the second matching process is repeatedly performed by the second matching processing unit 306, information indicating failure of matching with the second vehicle 10B is generated, and is transmitted to the first user terminal 20A and the third user terminal 20C.

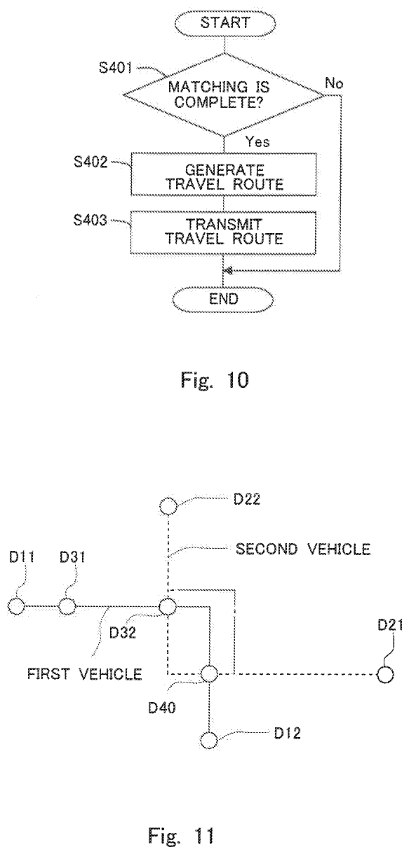

FIG. 10 is an example of a flowchart of a process for generating the travel route of the second vehicle 10B (a travel route generating process). The present flowchart is performed by the route generation unit 307 of the server 30 every predetermined period of time. Additionally, the flowchart illustrated in FIG. 10 may alternatively be performed subsequent to the second matching process illustrated in FIG. 9. In step S401, whether or not matching between the first vehicle 10A and the second vehicle 10B is completed by the second matching processing unit 306 is determined. In the case where an affirmative determination is made in step S401, step S402 is performed next, and in the case where a negative determination is made, the present flowchart is ended. In step S402, a travel route is generated in such a way that the second vehicle 10B matched in the second matching process may receive the package 100 from the first vehicle 10A, and may deliver the package 100 to the delivery destination. That is, a travel route is generated in such a way that the second vehicle 10B passes through the current position of the second vehicle 10B, the hand-over location of the package 100, the delivery destination of the package 100, and the travel destination of the second vehicle 10B in this order. Then, in step S403, the travel route is transmitted from the server 30 to the second user terminal 20B.

Additionally, in the present embodiment, the hand-over location of the package 100 is set on the travel route of the first vehicle 10A, but the hand-over location may instead be set on the travel route of the second vehicle 10B. In this case, for example, the second matching processing unit 306 sets, as the hand-over location, an arbitrary location on the scheduled travel route of the second vehicle 10B which is within the predetermined range of the scheduled travel route of the first vehicle 10A. Then, the route generation unit 307 generates the travel route of the first vehicle 10A, instead of generating the travel route of the second vehicle 10B. Furthermore, the hand-over location may be set within the predetermined range of the travel route the first vehicle 10A and within the predetermined range of the travel route of the second vehicle 10B. In this case, the route generation unit 307 generates the travel routes of the vehicle 10A and the second vehicle 10B in such a way that both the first vehicle 10A and the second vehicle 10B pass through the hand-over location. Additionally, with respect to reloading of a package from the first vehicle 10A to the second vehicle 108, the package 100 may be handed by the first user to the second user, or the first user may deposit the package 100 at a warehouse, a shop or the like, and the second user may later receive the package 100 at the warehouse, the shop or the like. Furthermore, in the case of an autonomous vehicle, the package may be directly reloaded by providing an apparatus allowing hand-over of packages in the first vehicle 10A and the second vehicle 10B, or a third person may reload the package at a warehouse, a shop or the like.

FIG. 11 is a diagram illustrating the travel routes of the first vehicle 10A and the second vehicle 10B in a simplified manner. A solid line indicates the travel route of the first vehicle 10A after the first matching process is ended, and a broken line indicates the travel route of the second vehicle 10B after the second matching process is ended. Furthermore, a dash-dotted line indicates the scheduled travel route of the second vehicle 10B before the second matching process is performed. A departure point of the first vehicle 10A is indicated by D11, and the travel destination of the first vehicle 10A is indicated by D12. A departure point of the second vehicle 10B is indicated by D21, and the travel destination of the second vehicle 10B is indicated by D22. The source location of the package 100 is indicated by D31, and the delivery destination of the package 100 is indicated by D32. The hand-over location of the package 100 is indicated by D40.

In FIG. 11, because the scheduled travel route of the second vehicle 10B before the second matching process is performed does not intersect the travel route of the first vehicle 10A, the package 100 is not reloaded from the first vehicle 10A to the second vehicle 10B. However, when the travel route of the second vehicle 10B is changed to pass through the hand-over location D40 on the travel route of the first vehicle 10A, the package 100 may be reloaded from the first vehicle 10A to the second vehicle 10B at the hand-over location D40. Moreover, in FIG. 11, the scheduled travel route of the second vehicle 10B before the second matching process is performed does not pass through the delivery destination D32. However, when the travel route of the second vehicle 10B is changed so as to cause the second vehicle 10B to pass through the delivery destination D32, delivery of the package 100 is enabled.

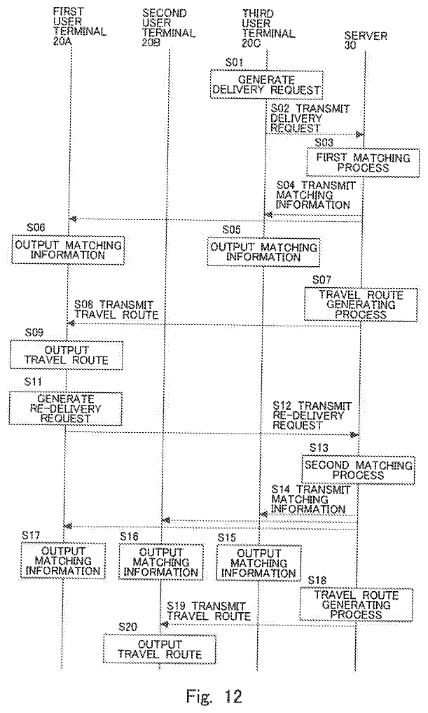

Next, an operation of the delivery system 1 will be described. FIG. 12 is a diagram illustrating a sequence of processes by the delivery system 1. Additionally, the sequence diagram illustrated in FIG. 12 assumes a case where there is one each of the first user, the second user, and the third user. It is also assumed that the current position of the first user (or the current position of the first vehicle 10A) and the current position of the second user (or the current position of the second vehicle 10B) are transmitted from the respective user terminals 20 to the server 30 eve predetermined period of time.

First, when the third user inputs, to the third user terminal 20C, a wish for delivery of the package 100, and the source location, the delivery destination, and the delivery period of the package 100, the third user terminal 20C generates the delivery request and the package information (a process in S01). Then, the delivery request and the package information are transmitted from the third user terminal 20C to the server 30 (a process in S02). When the delivery request and the package information are received from the third user terminal 20C, the server 30 performs the first matching process (a process in S03). In S03, the server 30 performs the firs thing process illustrated in FIG. 7. The server 30 searches for and matches the first vehicle 10A which is able to deliver the package 100, on the basis of the package information stored in the package information DB 312 and the vehicle information stored in the vehicle information DB 313. Then, when the matching is complete, the matching information is transmitted to the first user terminal 20A and the third user terminal 20C (a process in S04), and information corresponding to the matching information is output to the output unit 25 at the first user terminal 20A and the third user terminal 20C (processes in S05, S06).

Furthermore, the server 30 generates the travel route of the first vehicle 10A on the basis of the package information of the package 100 and the vehicle information of the first vehicle 10A (a process in S07). In S07, the server 30 performs the travel route generating process illustrated in FIG. 8. The travel route is generated in such a way that the first vehicle 10A passes through the current position of the first vehicle 10A, the source location of the package 100, the delivery destination of the package 100, and the travel destination of the first vehicle 10A in this order. Information about the generated travel route is transmitted from the server 30 to the first user terminal 20A (a process in S08). The first user terminal 20A which received the information about the travel route outputs the travel route to the output unit 25, and guides the first user along the travel route (a process in S09).

Furthermore, in the case where the first user fails to hand over the package 100 at the delivery destination, the first user performs input to the first user terminal 20A to the effect. Then, the first user terminal 20A generates a re-delivery request (a process in S11). Additionally, in the case where the first vehicle 10A is an autonomous vehicle, the re-delivery request is generated in a case where the package 100 is not received within a predetermined period of time (such as five minutes), for example. The re-delivery request is transmitted from the first user terminal 20A to the server 30 (a process in S12). When the re-delivery request is received from the first user terminal 20A, the server 30 performs the second matching process (a process in S13). In S13, the server 30 performs the second matching process illustrated in FIG. 10. The server 30 searches for and matches the second vehicle 10B which is able to receive the package 100 from the first vehicle 10A and to deliver the package 100 to the delivery destination, on the basis of the package information stored in the package information DB 312 and the vehicle information stored in the vehicle information DB 313. Then, when the matching is complete, the matching information is transmitted to the user terminals 20 (a process in S14), and information corresponding to the matching information is output to the output unit 25 at the user terminals 20 (processes in S15, S16, S17).

Furthermore, the server 30 generates the travel route of the second vehicle 10B on the basis of the package information of the package 100, the vehicle information of the first vehicle 10A, and the vehicle information of the second vehicle 10B (a process in S18). In S18, the server 30 performs the travel route generating process illustrated in FIG. 11, The travel route is generated in such a way that the second vehicle 10B passes through the current position of the second vehicle 10B, the hand-over location, the delivery destination of the package 100, and the travel destination of the second vehicle 10B this order, information about the generated travel route transmitted from the server 30 to the second user terminal 20B (a process in S19). The second user terminal 20B which received the information about the travel route outputs the travel route to the output unit 25, and guides the second user along the travel route (a process in S20).

Additionally, the travel route generating process in S18 may be performed after the second matching process is performed in S13 and before the matching information is transmitted in S14. In this case, the travel route may be included in the matching information.

Furthermore, the matching information that is transmitted from the second matching processing unit 306 to the third user terminal 20C may include information about a scheduled time of arrival of the second vehicle 10B at the delivery destination (hereinafter referred to also as “scheduled arrival time”). In this case, the route generation unit 307 performs the travel route generating process illustrated in FIG. 10 and generates the travel route of the second vehicle 10B, before the second matching processing unit 306 transmits the matching information tri the third user terminal 20C. Then, the second matching processing unit 306 calculates, on an assumption that the second vehicle 10B travels along the travel route, a time until the second vehicle 10B arrives at the delivery destination and the scheduled arrival time, on the basis of the travel distance of the second vehicle 10B from the current position to the travel destination and a speed of the second vehicle 10B. Additionally, the speed of the second vehicle 10B is predicted on the basis of a speed limit on each road, an average speed on each road, road congestion information, and the like. A known technique may be used to predict the speed of the second vehicle 10B. The speed limit on each road and the average speed on each road are stored in the auxiliary memory unit the server 30 in the form of databases, for example. Furthermore, as the road congestion information, information collected at a server of a third person may be obtained through the communication unit 34, for example. The second matching processing unit 306 transmits information about the scheduled arrival time to the third user terminal 20C by including the information in the matching information. The third user terminal 20C which received the matching information causes the output unit 25 to display the scheduled arrival time.

As described above, with the delivery system 1 according to the present embodiment, even in a case where the package 100 fails to be handed over to the third user by the first vehicle 10A, the package 100 may be delivered by the second vehicle 10B, by reloading the package 100 to the second vehicle 10b. Accordingly, the first u does not have to head to the delivery destination for delivery again. Furthermore, a time taken to re-deliver the package may be reduced. Re-delivery of the package may thus be performed efficiently.

### Second Embodiment

In a present embodiment, at a time of re-delivery of the package 100, the third user specifies a desired delivery period. In a case where the package 100 is not handed over due to absence of the third user at the delivery destination, the third user is possibly still absent if the second vehicle 10B re-delivers the package 100 to the delivery destination within a short time. Then, delivery has to be performed yet again. However, if the third user sends information about a period when the package 100 is desired to be received (a re-delivery period) to the server 30 through the third user terminal 20C, and the second vehicle 10B delivers the package 100 in the period, the package 100 may be more reliably handed over. Additionally, reloading of the package from the first vehicle 10A to the second vehicle 10B may be performed by the first user handing the package 100 to the second user, by the first user depositing the package 100 at a warehouse, a shop or the like and the second user later receiving the package 100 at the warehouse, the shop or the like. Furthermore, in the case of an autonomous vehicle, the package may be directly reloaded by providing an apparatus allowing hand-over of packages in the first vehicle 10A and the second vehicle 10B, or a third person may reload the package at the warehouse, the shop or the like. Furthermore, the travel destination of the first vehicle 10A may be set as the hand-over location, and the first vehicle 10A may keep the package 100 until the second vehicle 10B arrives.

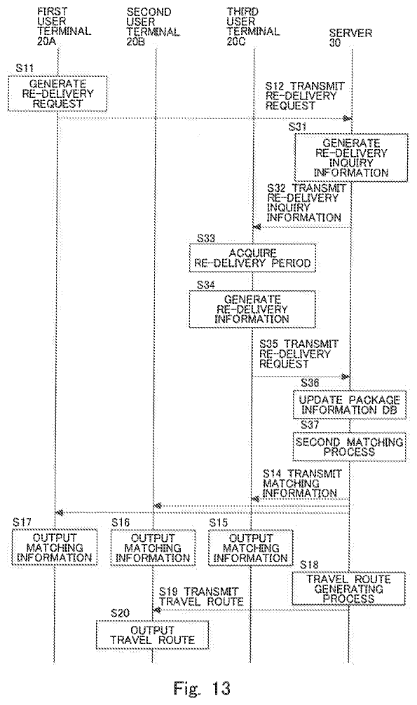

Next, an operation of the delivery system 1 will be described. FIG. 13 is a diagram illustrating a sequence of processes by the delivery system 1. The sequence diagram illustrated in FIG. 13 assumes that the hand-over location is set on the travel route of the first vehicle 10A. Additionally, processes up to S12 are the same as those in the sequence diagram illustrated in FIG. 12, and illustration and description of a part of the same processes are omitted. When a re-delivery request is transmitted in S12 from the first user terminal 20A to the server 30, the server 30 generates information ;re-delivery inquiry information) for inquiring of the third user about a period when the package 100 desired to be re-delivered (a process in S31), and transmits the information to the third user terminal 20C (a process in S32). When the third user terminal 20C receives the re-delivery inquiry information, a screen urging input of a period when re-deliver desired is displayed by the output unit 25. The third user inputs the period when re-delivery is desired, through the input unit 24 to the third user terminal 20C. The third user terminal 20C acquires t o period when re-delivery is desired by the third user (a re-delivery period) by the input (a process in S33). Then, the third user terminal 20C generates information (re-delivery information) about the period when re-delivery is desired (a process in S34), and transmits the information to the server 30 (a process in S35).

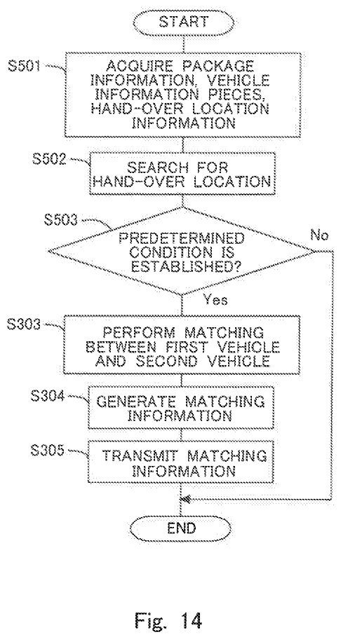

When the re-delivery information is received from the third user terminal 20C, the server 30 updates the delivery period field for the package 100 in the package information table stored in the package information DB 312 (a process in S36). The delivery period of the package 100 is thereby changed to the delivery period desired by the third user. Then, the server 30 performs the second matching process (a process in S37). In S37, the server 30 may perform the second matching process illustrated in FIG. 9 or may perform a second matching process illustrated in FIG. 14 described later.

A plurality of hand-over locations where the package 100 may be temporarily deposited may be registered in advance. The package 100 may be reloaded from the first vehicle 10A to the second vehicle 10B through one of such hand-over locations. Information about the hand-over locations is stored in the auxiliary memory unit 33 of the server 30, for example. The second matching processing unit 306 in this case searches for a hand-over location which is within a predetermined range of the travel route of the first vehicle 10A, from the delivery destination of the package 100 to the travel destination of the first vehicle 10A. Moreover, the second matching processing unit 306 searches for and matches the second vehicle 10B in which the searched hand-over location and the delivery destination are both included within a predetermined range from the scheduled travel route of the second vehicle 10B at the re-delivery period of the package 100.

FIG. 14 is an example of a flowchart of the second matching process according to the present embodiment. Steps in which processes the same as those in the flowchart illustrated in FIG. 9 are performed will be denoted by same reference signs, and a description thereof will be omitted. Additionally, i t is assumed here that the server 30 receives beforehand the user information of the first user and the vehicle information of the first vehicle 10A from the first user terminal 20A, the user information of the second user and the vehicle information of the second vehicle 10B from the second user terminal 20B, and the user information of the third user and the package information from the third user terminal 20C. It is also assumed that a plurality of hand-over locations are registered in the server 30.

In step S501, package information of the package 100 associated with the re-delivery request, among package information pieces stored in the package information DB 312, vehicle information corresponding to the first user terminal 20A which transmitted the re-delivery request, among vehicle information pieces stored in the vehicle information DB 313, vehicle information which is one vehicle information piece among vehicle information pieces stored in the vehicle information DB 313 and which is associated with the second vehicle 10B different from the first vehicle 10A, and information about the hand-over location are acquired.

In step S502, a hand-over location is searched. The second matching processing unit 306 searches for a hand-over location which is within a predetermined range of the travel route of the first vehicle 10A, from the delivery destination of the package 100 to the travel destination of the first vehicle 10A, on the basis of the package information, the vehicle information pieces, and the information about the hand-over location acquired in step S501.

Next, in step S503, whether or not a predetermined condition allowing the package 100 to be delivered to the delivery destination by the second vehicle 10B, corresponding to the one vehicle information piece acquired in step S501, when the second vehicle 10B travels to the travel destination is established is determined. The “predetermined condition” here is a condition for determining whether or not (the second vehicle 10B may relatively easily receive the package 100, and whether or not the package 100 may be relatively easily delivered to the delivery destination by the second vehicle 10B. Specifically, the second matching processing unit 306 determines that the predetermined condition is established, in a case where both the hand-over location searched in step S502 and the delivery destination of the package 100 are within a predetermined range of the scheduled travel route of the second vehicle 10B in the delivery period of the package 100 specified by the third user. The predetermined range here is a range where a burden on the second user remains within an allowable range even when the second vehicle 10B changes the travel route, and may be the same as or different from the predetermined range according to the first matching process. That is, if the delivery period of the package 100 and the traveling period of the second vehicle 10B are the same, the package 100 may be delivered by the second vehicle 10B in a period when delivery is desired by the third user. Furthermore, if both the hand-over location and the delivery destination of the package 100 are within the predetermined range of the scheduled travel route of the second vehicle 10B, a change that is made in the travel route of the second vehicle 10B is relatively small, and a burden on the second user may be reduced. In the case where an affirmative determination is made in step S503, step S303 is performed next, and in the case where a negative determination is made, the present flowchart is temporarily ended. Additionally, the second matching processing unit 306 repeatedly performs the process illustrated in FIG. 14 while changing the vehicle information of the second vehicle 10B. The second matching processing unit 306 may also repeatedly perform the process illustrated in FIG. 14 while changing the hand-over location.

Additionally, in a case where a period when the package 100 is unloaded at he hand-over location from the first vehicle 10A and a period when re-delivery is desired by the third user are apart (for example, in different days), a correlation between the current position of the second vehicle 10B and a position of the second vehicle 10B in the period when re-delivery is desired by the third user is low, and thus, the second vehicle 10B which is matched by the second matching process is possibly not appropriate. By performing the second matching process on the basis of information about a departure point of the second vehicle 10B in the period when re-delivery is desired by the third user, instead of information about the current position of the second vehicle 10B, a more appropriate second vehicle 10B may be matched. In this case, the vehicle information table in the vehicle information DB 313 may include a departure point field where information indicating the departure point of the second vehicle 10B is input. Information about the departure point of the second vehicle 10B in the period when re-delivery is desired by the third user may be stored in the vehicle information DB 313, and at the time of generation of the scheduled travel route of the second vehicle 10B by the second matching process, the scheduled travel route may be generated to pass through the departure point and the travel destination of the second vehicle 103 in this order.

As described above, with the delivery system 1 according to the present embodiment, by acquiring the period when delivery is desired from the third user, the package 100 may be more reliably delivered by the second vehicle 10B.

### Third Embodiment

In a present embodiment, in the case where there are a plurality of second vehicles 10B that can be matched with the first vehicle 10A, the third user selects one of the second vehicles 10B. For example, in the case where there are a plurality of second vehicles 10B with different scheduled arrival times at the delivery destination, the third user may select one second vehicle 10B according to a time when the package can be received. Furthermore, for example, in the case where there is a fee for re-delivery, and there are a plurality of second vehicles 10B with different amounts of fees, the third user may select one second vehicle 10B according to the fee. Moreover, models of the second vehicles 10B or the user information of the second users may be provided to the third user, and the third user may select one second vehicle 10B according to likings. In the case where there are a plurality of second vehicles 10B that can be matched with the first vehicle 10A, information necessary for the third user to select one second vehicle 10B (hereinafter referred to also as “second vehicle information”) is transmitted by the second matching processing unit 306 to the third user terminal 20C. The third user terminal 20C which received the second vehicle information urges the third user to select one second vehicle 10B. When one second vehicle 10B is selected by the third user, information about the one second vehicle 10B selected by the third user (hereinafter referred to also as “selection information”) is transmitted from the third user terminal 200 to the server 30. The second matching processing unit 306 matches the first vehicle 10A and the second vehicle 10B on the basis of the selection information, and generates matching information.

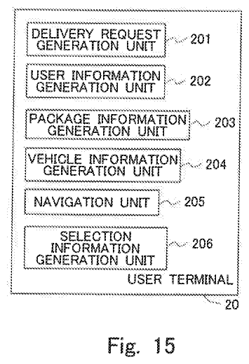

FIG. 15 is a diagram illustrating a functional configuration of the user terminal 20. Differences to the functional configuration of the user terminal 20 illustrated in FIG. 6 will be mainly described. The user terminal 20 further includes a selection information generation unit 206, as a functional configure element. The processor 21 of the user terminal 20 performs a process by the selection information generation unit 206 by a computer program on the main memory unit 22. The process may be partially implemented by a hardware circuit.

The selection information generation unit 206 generates information about the second vehicle 10B that is selected by the third user (i.e., the selection information). The selection information generation unit 206 displays, on the output unit 25, the information about the second vehicle 10B (the second vehicle information) and an operation screen urging selection of the second vehicle 10B. When the third user performs input to the input unit 24 to the effect that the second vehicle 10B is selected, the selection information generation unit 206 generates selection information according to the input. The generated selection information is transmitted by the selection information generation unit 206 to the server 30.

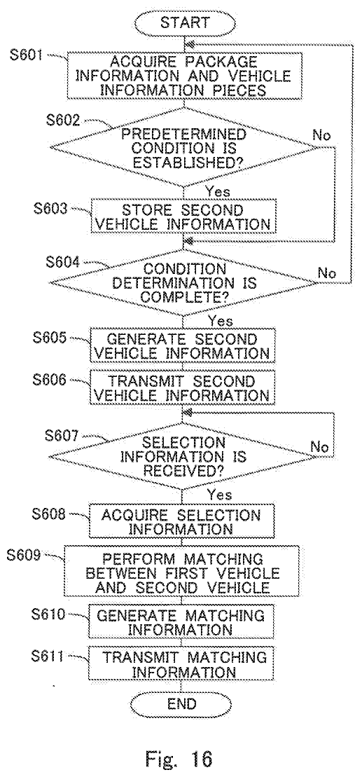

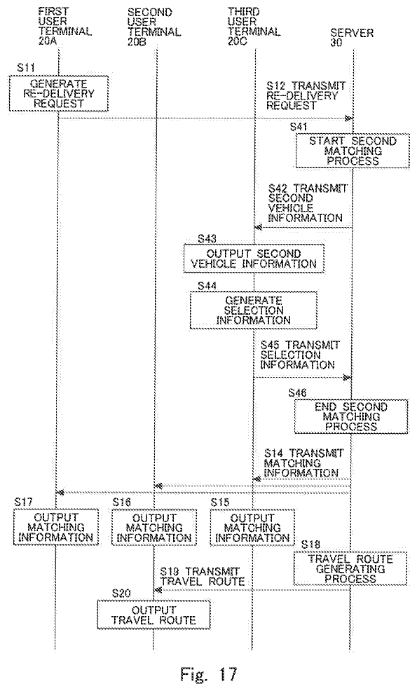

FIG. 16 is an example of a flowchart of the second matching process according to the present embodiment. The second matching process illustrated in FIG. 16 is performed for the vehicle 10A which failed to hand over the package 100. The second matching process is performed by the second matching processing unit 306, with reception of the re-delivery request by the server 30 as a trigger. Additionally, it is assumed here that the server 30 receives beforehand the user information of the first user and the vehicle information of the first vehicle 10A from the first user terminal 20A, the user information of the second user and the vehicle information of the second vehicle 10B from each of a plurality of second user terminals 20B, and the user information of the third user and the package information from the third user terminal 20C,

In step S601, package information of the package 100 associated with the re-delivery request, among package information pieces stored in the package information DB 312, vehicle information associated with the first vehicle 10A corresponding to the first u terminal 20A which transmitted the re-delivery request, among vehicle information pieces stored in the vehicle information DB 313, and vehicle information which is one vehicle information piece among vehicle information pieces stored in the vehicle information DB 313 and which is associated with the second vehicle 10B different from the first vehicle 10A are acquired.

Next, in step S602, whether or not a predetermined condition allowing delivery of the package 100 to the delivery destination by the second vehicle 10B is established is determined on the basis of the package information and the vehicle information pieces acquired in step S601. A process the same as that in step S302 is performed here. In the case where an affirmative determination is made in step S602, step S603 is performed next, and in the case where a negative determination is made, step S604 is performed.

In step S603, information about the second vehicle 10B is stored in the auxiliary memory unit 33. The information about the second vehicle here includes the vehicle information, the user information of the corresponding second user, or the like. In this case, it is sufficient if information allowing identification of the second vehicle 10B is stored. Then, in step S604, whether or not the process in step S602 complete for all the vehicle information pieces stored in the vehicle information DB 313 is determined. In the case where an affirmative determination is made in step S604, step S605 is performed next, and in the case where a negative determination is made, step S601 is performed again That is, the process in step S602 is repeatedly performed while changing the vehicle information.

In step S605, information about the second vehicle 10B (i.e., the second vehicle information) to be transmitted to the third user terminal 20C is generated. This information is information that is necessary for the third user to select the second vehicle 10B (such as the traveling period, the fee, or the user information (such as name, age, gender, vehicle type, etc.)), and is information that is associated with the second vehicle 10B or the second user. The second vehicle information may be information the same as the information that is stored in step S603. The second vehicle information is acquired in advance by the server 30 through the second user terminal 20B, and is stored in the auxiliary memory unit 33. Then, in step S606, the generated second vehicle information is transmitted to the third user terminal 20C.

In step S607, whether or not the selection information is received from the third user terminal 20C is determined. The selection information is information that is generated by the third user terminal 20C, and is information about the one second vehicle 10B selected by the third user. In the case where an affirmative determination is made in step S607, step S608 is performed next, and the selection information is acquired. On the other hand, in the case where a negative determination is made in step S607, step S607 is performed again.

Next, in step S609, the package 100 according to the package information acquired in step S601, the first vehicle 10A according to the vehicle information acquired in step S601, and the second vehicle 102 corresponding to the selection information acquired in step S608 are matched with one another. Next, in step S610, matching information to be transmitted to each of the third user terminal 20C corresponding to the package 100 matched in step S609, the first user terminal 20A corresponding to the first vehicle 10A matched in step S609, and the second user terminal 20B corresponding to the second vehicle 10B matched in step S609 is generated. Here, a process the same as that in step S304 is performed. The matching information pieces generated in step S610 are transmitted to the user terminals 20 in stems S611.

Next, an operation of the delivery system 1 will be described. FIG. 17 is a diagram illustrating a sequence of the process by the delivery system 1. Additionally, processes up to S12 are the same as those in the sequence diagram illustrated in FIG. 12, and illustration and description of a part of the same processes are omitted. The second user terminal 20B illustrated in FIG. 17 is the second user terminal 20B corresponding to the second vehicle 10B selected by the third user. When a re-delivery request is transmitted from the first user terminal 20A to the server 30 in S12, the server 30 starts the second matching process illustrated in FIG. 16 (a process in S41). In the second matching process, the server 30 transmits the second vehicle information to the third user terminal 20C (a process in S42). When the third user terminal 20C receives the second vehicle information, the output unit 25 is caused to display a screen urging selection of the second vehicle 10B. Then, the third user inputs the selected second vehicle 10B to the third user terminal 20C through the input unit 24. The third user terminal 20C generates, by the input, information (selection information) about the one second vehicle 10B selected by the third user (a process in 344), and transits the information to the server 30 (a process in S45). When the server 30 receives the selection information, the firs vehicle 10A and the second vehicle 10B are matched with each other, and the second matching process is ended (a process in S46).

As described above, with the delivery system 1 according to the present embodiment, the third user may select the second vehicle 10B, and thus, convenience is increased for the third user.

### Other Embodiments

The embodiments described above are merely examples, and the present disclosure may be embodied while being changed as appropriate within the scope of the present disclosure. The embodiments described above describe a case of re-delivery of the package 100, but in the case where the third user is absent at the time of re-delivery of the package 100, re-delivery of the package 100 may be performed yet again in a similar manner. In this case, the server 30 treats the second vehicle 10B heading for re-delivery as the first vehicle 10A, and matches the new second vehicle 10B.

The processes and means described in the present disclosure may be freely combined and embodied the extent that no technical conflicts exist

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus including a controller configured to:
detect failure to hand over a package by delivery of the package by a first vehicle in which the package that is scheduled to be delivered to a delivery destination is loaded; and
perform matching, with the first vehicle, in a case where failure to hand over the package is detected, of a second vehicle that is different from the first vehicle and for which a condition allowing reloading of the package from the first vehicle and a condition allowing delivery of the package to the delivery destination are established, where matching is performed on a basis of information about traveling of the first vehicle, information about the package, and information about traveling of the second vehicle.

2. The information processing apparatus according to claim 1, wherein the controller is configured to determine that the condition allowing reloading of the package from the first vehicle to the second vehicle is established, in a case where the second vehicle is scheduled to move through a location within a first predetermined range of any of locations on a route, between the delivery destination and a first travel destination that is a destination of the first vehicle, along which the first vehicle is scheduled to travel.

3. The information processing apparatus according to claim 2, wherein the controller is configured to determine that the condition allowing delivery of the package to the delivery destination by the second vehicle is established, in a case where the second vehicle is scheduled to move through a location within a second predetermined range of the delivery destination after moving through a location within the first predetermined range.

4. The information processing apparatus according to claim 2, wherein the controller is configured to:
acquire information about a delivery period that is a period when delivery of the package by the second vehicle is desired by a user who is to receive the package at the delivery destination; and
determine, in a case where the information about the delivery period is acquired, that the condition allowing delivery of the package to the delivery destination by the second vehicle is established, in a case where the second vehicle is scheduled to move, in the delivery period, through a location within a second predetermined range of the delivery destination after moving through a location within the first predetermined range.

5. The information processing apparatus according to claim 2, wherein the controller is configured to:
set a hand-over location where the package is reloaded from the first vehicle to the second vehicle, within the first predetermined range of any of locations on the route, between the delivery destination and the first travel destination, along which the first vehicle is scheduled to travel; and
transmit information about the hand-over location to a terminal corresponding to the first vehicle and a terminal corresponding to the second vehicle.

6. The information processing apparatus according to claim 1, wherein the controller is configured to:
provide information about each of a plurality of the second vehicles to a terminal corresponding to a user who is to receive the package at the delivery destination, in a case where there are a plurality of the second vehicles for which the condition allowing reloading of the package from the first vehicle and the condition allowing delivery of the package to the delivery destination are established;
acquire, from the terminal corresponding to the user, information about one second vehicle selected by the user from the plurality of the second vehicles; and
perform matching between the first vehicle and the one second vehicle.

7. An information processing method including:
detecting failure to hand over a package by delivery of the package by a first vehicle in which the package that is scheduled to be delivered to a delivery destination is loaded; and
performing matching, the first vehicle, in a case where failure to hand over the package is detected, of a second vehicle that is different from the first vehicle and for which a condition allowing reloading of the package from the first vehicle and a condition allowing delivery of the package to the delivery destination are established, where matching is performed on a basis of information about traveling of the first vehicle, information about the package, and information about traveling of the second vehicle.

8. A program for causing a computer to:
detect failure to hand over a package by delivery of the package by a first vehicle in which the package that is scheduled to be delivered to a delivery destination is loaded; and
perform matching, with the first vehicle, in a case where failure to hand over the package is detected, of a second vehicle that is different from the first vehicle and for which a condition allowing reloading of the package from the first vehicle and a condition allowing delivery of the package to the delivery destination are established, where matching is performed on a basis of information about traveling of the first vehicle, information about the package, and information about traveling of the second vehicle.
